(19) United States
(12) Patent Application Publication
(10) Pub. No.: US 2026/0058144 A1
(43) Pub. Date: Feb. 26, 2026

(54) POSITIVE ELECTRODE AND RECHARGEABLE LITHIUM BATTERY INCLUDING THE SAME

(71) Applicant: Samsung SDI Co., Ltd., Yongin-si (KR)

(72) Inventors: Inah KANG, Yongin-si (KR); MYUNGHEUI WOO, Yongin-si (KR); SiYoung CHA, Yongin-si (KR); Hongjin LIM, Yongin-si (KR); Aehui GOH, Yongin-si (KR); Minji SIM, Yongin-si (KR); Hanmam JEONG, Yongin-si (KR)

(21) Appl. No.: 19/083,281

(22) Filed: Mar. 18, 2025

(30) Foreign Application Priority Data
Aug. 22, 2024 (KR) 10-2024-0112781

(51) Int. Cl. H01M 4/62; H01M 4/02; H01M 10/052

(52) U.S. Cl. CPC H01M 4/62; H01M 10/052; H01M 2004/028

(57) ABSTRACT

A positive electrode includes a positive electrode active material, a binder, a conductive material, and an additive represented by Chemical Formula 1-1 or Chemical Formula 1-2.

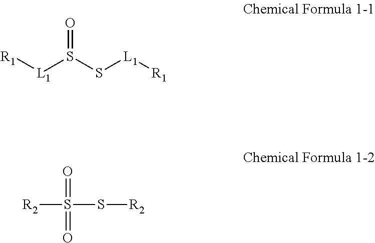

### CROSS-REFERENCE TO RELATED APPLICATION

The present application claims priority to and the benefit of Korean Patent Application No. 10-2024-0112781, filed on Aug. 22, 2024, in the Korean Intellectual Property Office, the entire disclosure of which is incorporated herein by reference.

### BACKGROUND

### 1. Field

Embodiments of the present disclosure described herein are related to a positive electrode and a rechargeable lithium battery including the positive electrode.

### 2. Description of Related Art

Recently, with the rapid proliferation of battery-powered electronic devices (such as mobile phones and/or laptop computers) and electric vehicles, there is a growing demand for rechargeable batteries that offer high energy density and capacity. Consequently, intensive research efforts have been focused on enhancing the performance of rechargeable batteries, particularly rechargeable lithium batteries.

A rechargeable lithium battery includes a positive electrode, a negative electrode, and an electrolyte. The positive and negative electrodes each include an active material that allows for intercalation and deintercalation processes. The battery generates electrical energy through oxidation and reduction reactions when lithium ions are intercalated and deintercalated.

### SUMMARY

Aspects according to one or more aspects of embodiments are directed toward a positive electrode whose stability is enhanced (e.g., improved).

Aspects according to one or more aspects of embodiments are directed toward a rechargeable lithium battery including the positive electrode.

Additional aspects will be set forth in part in the description which follows and, in part, will be apparent from the description, or may be learned by practice of the presented embodiments of the present disclosure.

According to one or more embodiments of the present disclosure, a positive electrode may include: a positive electrode active material; a binder; a conductive material; and an additive represented by Chemical Formula 1-1 or Chemical Formula 1-2.

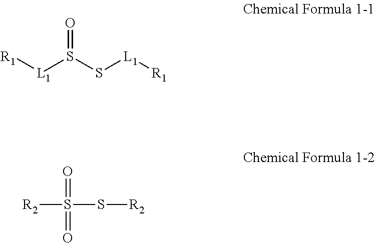

In Chemical Formula 1-1,

L₁ may each independently be a substituted or unsubstituted C1 to C10 alkylene group.

R₁ may each independently be hydrogen, a C1 to C20 alkyl group, a C2 to C20 alkenyl group, a C2 to C20 alkynyl group, a C3 to C20 cycloalkyl group, or a C6 to C20 aryl group.

At least one of R₁ may be a C2 to C20 alkenyl group.

In Chemical Formula 1-2,

R₂ may each independently be hydrogen, a C1 to C20 alkyl group, a C2 to C20 alkenyl group, a C2 to C20 alkynyl group, a C3 to C20 cycloalkyl group, or a C6 to C20 aryl group.

At least one of R₂ may be a C6 to C20 aryl group.

According to one or more embodiments of the present disclosure, a rechargeable lithium battery may include: the positive electrode discussed above; a negative electrode that includes a negative electrode active material; and an electrolyte for the rechargeable lithium battery.

### BRIEF DESCRIPTION OF THE DRAWINGS

FIG. 1 illustrates a conceptual diagram showing a rechargeable lithium battery according to one or more embodiments of the present disclosure.

FIGS. 2-5 illustrate diagrams each showing a rechargeable lithium battery according to one or more embodiments, with FIG. 2 showing a cylindrical battery, FIG. 3 showing a prismatic battery, and FIGS. 4 and 5 showing pouch-type (kind) batteries.

### DETAILED DESCRIPTION

In order to sufficiently understand the configuration and effect of the present disclosure, one or more embodiments of the present disclosure will be described in more detail with reference to the accompanying drawings. It should be noted, however, that the present disclosure is not limited to the following example embodiments, and may be implemented in one or more suitable forms. Rather, the example embodiments are provided only to disclose the present disclosure and let those skilled in the art fully know the scope of the present disclosure.

In this description, it will be understood that, if (e.g., when) an element is referred to as being on another element, the element can be directly on the other element or intervening elements may be present between therebetween. In the drawings, thicknesses of some components are exaggerated for effectively explaining the technical contents. Like reference numerals refer to like elements throughout, and duplicative descriptions thereof may not be provided the specification.

Unless otherwise specially noted in this description, the expression of singular form may include the expression of plural form. In addition, unless otherwise specially noted, the phrase “A or B” may indicate “A but not B”, “B but not A”, and “A and B”. The terms “comprises/includes” and/or “comprising/including” used in this description do not exclude the presence or addition of one or more other components.

As used herein, the term “and/or” includes any and all combinations of one or more of the associated listed items. As used herein, expressions such as “at least one of”, “one of”, and “selected from”, when preceding a list of elements, modify the entire list of elements and do not modify the individual elements of the list. For example, “at least one of a, b or c”, “at least one selected from a, b and c”, etc., may indicate only a, only b, only c, both (e.g., simultaneously) a and b, both (e.g., simultaneously) a and c, both (e.g., simultaneously) b and c, all of a, b, and c, or variations thereof.

In the present disclosure, it will be understood that the term “comprise(s)/comprising,” “include(s)/including,” or “have/has/having” specifies the presence of stated features, integers, steps, operations, elements, and/or components, but do not preclude the presence or addition of one or more other features, integers, steps, operations, elements, components, and/or groups thereof. Additionally, the terms “comprise(s)/comprising,” “include(s)/including,” “have/has/having”, or other similar terms include or support the terms “consisting of” and “consisting essentially of,” indicating the presence of stated features, integers, steps, operations, elements, and/or components, without or essentially without the presence of other features, integers, steps, operations, elements, components, and/or groups thereof.

Further, the use of “may” when describing embodiments of the inventive concept refers to “one or more embodiments of the inventive concept.”

In this description, the term “combination thereof” may refer to a mixture, a stack, a composite, a copolymer, an alloy, a blend, or a reaction product.

In this description, unless otherwise separately defined, the term “substituted” may refer to that at least one hydrogen of a substituent or a compound is substituted by deuterium, a halogen group, a hydroxyl group, an amino group, a C1 to C30 amine group, a nitro group, a C1 to C40 silyl group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, C1 to C20 alkoxy group, a C1 to C10 fluoroalkyl group, a cyano group, and/or a (e.g., any suitable) combination thereof.

In more detail, the term “substituted” may refer to that at least one hydrogen of a substituent or a compound is substituted by deuterium, a halogen group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C10 fluoroalkyl group, or a cyano group. For example, the term “substituted” may refer to that at least one hydrogen of a substituent or a compound is substituted by deuterium, a halogen group, a C1 to C20 alkyl group, a C6 to C30 aryl group, a C1 to C10 fluoroalkyl group, or a cyano group. In one or more embodiments, the term “substituted” may refer to that at least one hydrogen of a substituent or a compound is substituted by deuterium, a halogen group, a C1 to C5 alkyl group, a C6 to C18 aryl group, a C1 to C5 fluoroalkyl group, or a cyano group. For example, the term “substituted” may refer to that at least one hydrogen of a substituent or a compound is substituted by deuterium, a cyano group, a halogen group, a methyl group, an ethyl group, a propyl group, a butyl group, a phenyl group, a biphenyl group, a terphenyl group, a trifluormethyl group, or a naphthyl group.

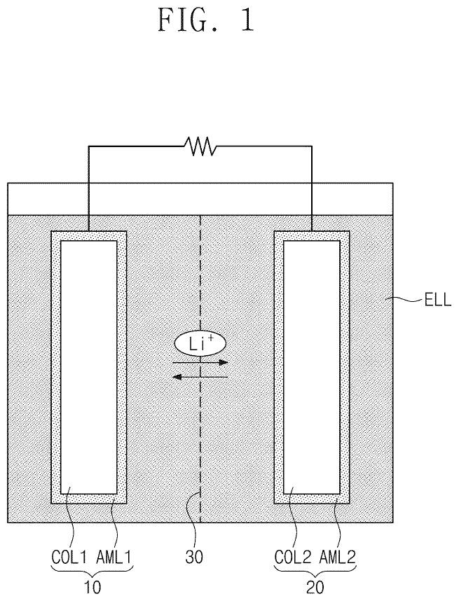

FIG. 1 illustrates a simplified conceptual diagram showing a rechargeable lithium battery according to one or more embodiments of the present disclosure. Referring to FIG. 1, a rechargeable lithium battery may include a positive electrode 10, a negative electrode 20, a separator 30, and an electrolyte ELL.

The positive electrode 10 and the negative electrode 20 may be spaced and/or apart (e.g., spaced apart or separated) from each other across the separator 30. The separator 30 may be arranged between the positive electrode 10 and the negative electrode 20. The positive electrode 10, the negative electrode 20, and the separator 30 may be in contact with the electrolyte ELL. The positive electrode 10, the negative electrode 20, and the separator 30 may be impregnated in the electrolyte ELL.

The electrolyte ELL may be a medium by which lithium ions are transferred between the positive electrode 10 and the negative electrode 20. In the electrolyte ELL, the lithium ions may move through the separator 30 toward one of the positive electrode 10 and the negative electrode 20.

### Positive Electrode 10

The positive electrode 10 for a rechargeable lithium battery may include a current collector COL1 and a positive electrode active material layer AML1 formed on the current collector COL1. The positive electrode active material layer AML1 may include a positive electrode active material and further include a binder and/or a conductive material (e.g., electron conductor).

For example, the positive electrode 10 may further include an additive that can serve as a sacrificial positive electrode.

An amount of the positive electrode active material may be about 90 wt % to about 99.5 wt % relative to 100 wt % of the positive electrode active material layer AML1. An amount of each of the binder and the conductive material (e.g., electron conductor) may be about 0.5 wt % to about 5 wt % relative to 100 wt % of the positive electrode active material layer AML1.

The binder may serve to improve attachment of positive electrode active material particles to each other and also to improve attachment of the positive electrode active material to the current collector COL1. The binder may include, for example, polyvinyl alcohol, carboxymethyl cellulose, hydroxypropyl cellulose, diacetyl cellulose, polyvinylchloride, carboxylated polyvinylchloride, polyvinylfluoride, ethylene oxide-containing polymer, polyvinylpyrrolidone, polyurethane, polytetrafluoroethylene, polyvinylidene fluoride, polyethylene, polypropylene, styrene-butadiene rubber, (meth)acrylated styrene-butadiene rubber, epoxy resin, (meth)acrylic resin, polyester resin, or nylon, but the present disclosure is not limited thereto.

The conductive material (e.g., electron conductor) may be used to provide an electrode with conductivity (e.g., electron conductor), and any suitable conductive material (e.g., electron conductor) that does not cause a chemical change in a battery may be used as the conductive material (e.g., electron conductor). The conductive material (e.g., electron conductor) may include, for example, a carbon-based material such as natural graphite, artificial graphite, carbon black, acetylene black, Ketjen black, carbon fiber, carbon nano-fiber, and carbon nano-tube; a metal powder or metal fiber containing one or more of copper, nickel, aluminum, and silver; a conductive polymer such as a polyphenylene derivative; and/or a (e.g., any suitable) mixture thereof.

Aluminum (Al) may be used as the current collector COL1, but the present disclosure is not limited thereto.

### Positive Electrode Active Material

The positive electrode active material in the positive electrode active material layer AML1 may include a compound (e.g., lithiated intercalation compound) that can reversibly intercalate and deintercalate lithium. For example, the positive electrode active material may include at least one kind of composite oxide including lithium and metal that is selected from among cobalt, manganese, nickel, and/or a (e.g., any suitable) combination thereof.

The composite oxide may include lithium transition metal composite oxide, for example, lithium-nickel-based oxide, lithium-cobalt-based oxide, lithium-manganese-based oxide, lithium-iron-phosphate-based compounds, cobalt-free nickel-manganese-based oxide, and/or a (e.g., any suitable) combination thereof.

For example, the positive electrode active material may include a compound expressed by one of chemical formulae LiₐA_{1-b}X_{b}O_{2-c}D_{c} (where 0.90≤a≤1.8, 0≤b≤0.5, and 0≤c≤0.05); LiₐMn_{2-b}X_{b}O_{4-c}D_{c} (where 0.90≤a≤1.8, 0≤b≤0.5, and 0≤c≤0.05); LiₐNi_{1-b-c}CO_{b}X_{c}O_{2-α}D_{α} (where 0.90≤a≤1.8, 0≤b≤0.5, 0≤c≤0.5, and 0<α<2); LiₐNi_{1-b-c}Mn_{b}X_{c}O_{2-α}D_{α} (where 0.90≤a≤1.8, 0≤b≤0.5, 0≤c≤0.5, and 0<α<2); LiₐNi_{b}Co_{c}L¹_{d}GₑO₂ (where 0.90≤a≤1.8, 0≤b≤0.9, 0≤c≤0.5, 0≤d≤0.5, and 0≤e≤0.1); LiₐNiG_{b}O₂ (where 0.90≤a≤1.8 and 0.001≤b≤0.1); LiₐCoG_{b}O₂ (where 0.90≤a≤1.8 and 0.001≤b≤0.1); LiₐMn_{1-b}G_{b}O₂ (where 0.90≤a≤1.8 and 0.001≤b≤0.1); LiₐMn₂G_{b}O₄ (where 0.90≤a≤1.8 and 0.001≤b≤0.1); LiₐMn_{1-g}G_{g}PO₄ (where 0.90≤a≤1.8 and 0≤g≤0.5); Li_{(3-f)}Fe₂(PO₄)₃ (where 0≤f≤2); LiₐFePO₄ (where 0.90≤a≤1.8).

In the chemical formulae above, A may be Ni, Co, Mn, and/or a (e.g., any suitable) combination thereof, X may be Al, Ni, Co, Mn, Cr, Fe, Mg, Sr, V, a rare-earth element, and/or a (e.g., any suitable) combination thereof, D may be O, F, S, P, and/or a (e.g., any suitable) combination thereof, G may be Al, Cr, Mn, Fe, Mg, La, Ce, Sr, V, and/or a (e.g., any suitable) combination thereof, and L¹ may be Mn, Al, and/or a (e.g., any suitable) combination thereof.

For example, the positive electrode active material may be a high-nickel-based positive electrode active material having a nickel amount of equal to or greater than about 80 mol %, equal to or greater than about 85 mol %, equal to or greater than about 90 mol %, equal to or greater than about 91 mol %, or equal to or greater than about 94 mol % and equal to or less than about 99 mol % relative to 100 mol % of metal devoid of (e.g., not including or excluding)_lithium in the lithium transition metal composite oxide. The high-nickel-based positive electrode active material may achieve high capacity and thus may be applied to a high-capacity and high-density rechargeable lithium battery.

### Negative Electrode 20

The negative electrode 20 for a rechargeable lithium battery may include a current collector COL2 and a negative electrode active material layer AML2 positioned on the current collector COL2. The negative electrode active material layer AML2 may include a negative electrode active material and may further include a binder and/or a conductive material (e.g., electron conductor).

For example, the negative electrode active material layer AML2 may include a negative electrode active material of about 90 wt % to about 99 wt %, a binder of about 0.5 wt % to about 5 wt %, and a conductive material (e.g., electron conductor) of about 0 wt % to about 5 wt %.

The binder may serve to improve attachment of negative electrode active material particles to each other and also to improve attachment of the negative electrode active material to the current collector COL2. The binder may include a non-aqueous binder, an aqueous binder, a dry binder, and/or a (e.g., any suitable) combination thereof.

The non-aqueous binder may include polyvinyl chloride, carboxylated polyvinyl chloride, polyvinyl fluoride, ethylene propylene copolymer, polystyrene, polyurethane, polytetrafluoroethylene, polyvinylidene fluoride, polyethylene, polypropylene, polyamide imide, polyimide, and/or a (e.g., any suitable) combination thereof.

The aqueous binder may include styrene-butadiene rubber, (meth)acrylated styrene-butadiene rubber, (meth)acrylonitrile-butadiene rubber, (meth)acrylic rubber, butyl rubber, fluoro elastomer, polyethylene oxide, polyvinyl pyrrolidone, polyepichlorohydrin, polyphosphazene, poly(meth)acrylonitrile, ethylene propylene diene copolymer, polyvinyl pyridine, chlorosulfonated polyethylene, latex, polyester resin, (meth)acrylic resin, phenolic resin, epoxy resin, polyvinyl alcohol, and/or a (e.g., any suitable) combination thereof.

When an aqueous binder is used as the negative electrode binder, a cellulose-based compound capable of providing viscosity may further be included. The cellulose-based compound may include one or more of carboxymethyl cellulose, hydroxypropylmethyl cellulose, methyl cellulose, and alkali metal salts thereof. The alkali metal may include Na, K, or Li.

The dry binder may include a fibrillizable polymer material, for example, polytetrafluoroethylene, polyvinylidene fluoride, polyvinylidene fluoride-hexafluoropropylene copolymer, polyethylene oxide, and/or a (e.g., any suitable) combination thereof.

The conductive material (e.g., electron conductor) may be used to provide an electrode with conductivity, and any suitable conductive material (e.g., electron conductor) that does not cause a chemical change in a battery may be used as the conductive material (e.g., electron conductor). For example, the conductive material (e.g., electron conductor) may include a carbon-based material such as natural graphite, artificial graphite, carbon black, acetylene black, Ketjen black, carbon fiber, carbon nano-fiber, and carbon nano-tube; a metal powder or metal fiber including one or more of copper, nickel, aluminum, and silver; a conductive polymer such as a polyphenylene derivative; and/or a (e.g., any suitable) mixture thereof.

The current collector COL2 may include a copper foil, a nickel foil, a stainless-steel foil, a titanium foil, a nickel foam, a copper foam, a polymer substrate coated with a conductive metal, and/or a (e.g., any suitable) combination thereof.

### Negative Electrode Active Material

The negative electrode active material in the negative electrode active material layer AML2 may include a material that can reversibly intercalate and deintercalate lithium ions, lithium metal, a lithium metal alloy, a material that can dope and de-dope lithium, or transition metal oxide.

The material that can reversibly intercalate and deintercalate lithium ions may include a carbon-based negative electrode active material, for example, crystalline carbon, amorphous carbon, and/or a (e.g., any suitable) combination thereof. For example, the crystalline carbon may include graphite such as non-shaped, sheet-shaped, flake-shaped, sphere-shaped, or fiber-shaped natural or artificial graphite, and the amorphous carbon may include soft carbon, hard carbon, mesophase pitch carbon, or calcined coke.

The lithium metal alloy may include an alloy of lithium and metal that is selected from among Na, K, Rb, Cs, Fr, Be, Mg, Ca, Sr, Si, Sb, Pb, In, Zn, Ba, Ra, Ge, Al, and Sn.

1 The material that can dope and de-dope lithium may include a Si-based negative electrode active material or a Sn-based negative electrode active material. The Si-based negative electrode active material may include silicon, silicon-carbon composite, SiOx (where 0<x≤2), Si-Q alloy (where Q is alkali metal, alkaline earth metal, Group 13 element, Group 14 element (except for Si), Group 15 element, Group 16 element, transition metal, a rare-earth element, and/or a (e.g., any suitable) combination thereof), and/or a (e.g., any suitable) combination thereof. The Sn-based negative electrode active material may include Sn, SnO₂, a Sn-based alloy, a combination thereof.

The silicon-carbon composite may be a composite of silicon and amorphous carbon. According to one or more embodiments, the silicon-carbon composite may have a structure in which the amorphous carbon is coated on a surface of the silicon particle. For example, the silicon-carbon composite may include a secondary particle (core) in which primary silicon particles are agglomerated (e.g., to be in a secondary particle form), and an amorphous carbon coating layer (shell) positioned on a surface of the secondary particle. The amorphous carbon may also be positioned between the primary silicon particles, and for example, the primary silicon particles may be coated with the amorphous carbon. The secondary particles may be present dispersed in an amorphous carbon matrix.

The silicon-carbon composite may further include crystalline carbon. For example, the silicon-carbon composite may include a core including crystalline carbon and silicon particles and may also include an amorphous carbon coating layer positioned on a surface of the core.

The Si-based negative electrode active material or the Sn-based negative electrode active material may be used in combination with a carbon-based negative electrode active material.

### Separator 30

Based on a type (kind) of the rechargeable lithium battery, the separator 30 may be present between positive electrode 10 and the negative electrode 20. The separator 30 may include one or more of polyethylene, polypropylene, and polyvinylidene fluoride, and may have a multi-layered separator thereof such as a polyethylene/polypropylene bi-layered separator, a polyethylene/polypropylene/polyethylene tri-layered separator, and a polypropylene/polyethylene/polypropylene tri-layered separator.

The separator 30 may include a porous substrate and a coating layer positioned on one or opposite surfaces of the porous substrate, which coating layer includes an organic material, an inorganic material, and/or a (e.g., any suitable) combination thereof.

The porous substrate may be a polymer layer including one selected from among polyolefin such as polyethylene and polypropylene, polyester such as polyethylene terephthalate and polybutylene terephthalate, polyacetal, polyamide, polyimide, polycarbonate, polyetherketone, polyaryletherketone, polyetherimide, polyamideimide, polybenzimidazole, polyethersulfone, polyphenyleneoxide, cyclic olefin copolymer, polyphenylenesulphide, polyethylene naphthalate, glass fiber, and polytetrafluoroethylene (e.g., TEFLON), or may be a copolymer or mixture including two or more of the materials mentioned above.

The organic material may include a polyvinylidenefluoride-based copolymer or a (meth)acrylic copolymer.

The inorganic material may include an inorganic particle selected from among Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, Boehmite, and/or a (e.g., any suitable) combination thereof, but the present disclosure is not limited thereto.

The organic material and the inorganic material may be mixed in one coating layer or may be present as a stack of a coating layer including the organic material and a coating layer including an inorganic material. That is, the coating layer including an organic material may be on the coating layer including an inorganic material or the coating layer including an inorganic material may be on the coating layer including an organic material. For example, the organic and inorganic materials may either be mixed together in a single coating layer or arranged in separate layers stacked on top of each other. In the latter case, the organic material layer may be on top of the inorganic material layer, or vice versa.

### Electrolyte ELL

The electrolyte ELL for a rechargeable lithium battery may include a non-aqueous organic solvent and a lithium salt.

The non-aqueous organic solvent may serve as a medium for transmitting ions that participate in an electrochemical reaction of the battery.

The non-aqueous organic solvent may include a carbonate-based solvent, an ester-based solvent, an ether-based solvent, a ketone-based solvent, an alcohol-based solvent, an aprotic solvent, and/or a (e.g., any suitable) combination thereof.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), or butylene carbonate (BC).

The ester-based solvent may include methyl acetate, ethyl acetate, n-propyl acetate, dimethyl acetate, methyl propionate, ethyl propionate, decanolide, mevalonolactone, valerolactone, or caprolactone.

The ether-based solvent may include dibutyl ether, tetraglyme, diglyme, dimethoxyethane, 2-methyltetrahydrofuran, 2.5-dimethyltetrahydrofuran, or tetrahydrofuran. The ketone-based solvent may include cyclohexanone. The alcohol-based solvent may include ethyl alcohol or isopropyl alcohol, and the aprotic solvent may include nitriles such as R—CN (where R is a hydrocarbon group having a C2 to C20 linear, branched, or cyclic structure and may include a double bond, an aromatic ring, or an ether group); amides such as dimethylformamide; dioxolanes such as 1,3-dioxolane or 1.4-dioxolane; or sulfolanes.

The non-aqueous organic solvent may be used alone or in a mixture of two or more substances.

In addition, if (e.g., when) a carbonate-based solvent is used, a cyclic carbonate and a chain carbonate may be mixed and used, and the cyclic carbonate and the chain carbonate may be mixed in a volume ratio of about 1:1 to about 1:9.

The lithium salt may be a material that is dissolved in the non-aqueous organic solvent to serve as a supply source of lithium ions in a battery and plays a role in enabling a basic operation of a rechargeable lithium battery and in promoting the movement of lithium ions between positive and negative electrodes. The lithium salt may include, for example, at least one selected from among LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂) (where x and y are integers of 1 to 20), lithium trifluoromethane sulfonate, lithium tetrafluoroethanesulfonate, lithium difluoro (oxalato) borate (LiDFOB), lithium difluorobis(oxalato)phosphate (LiDFOP), and lithium bis(oxalato) borate (LiBOB)

### Rechargeable Lithium Battery

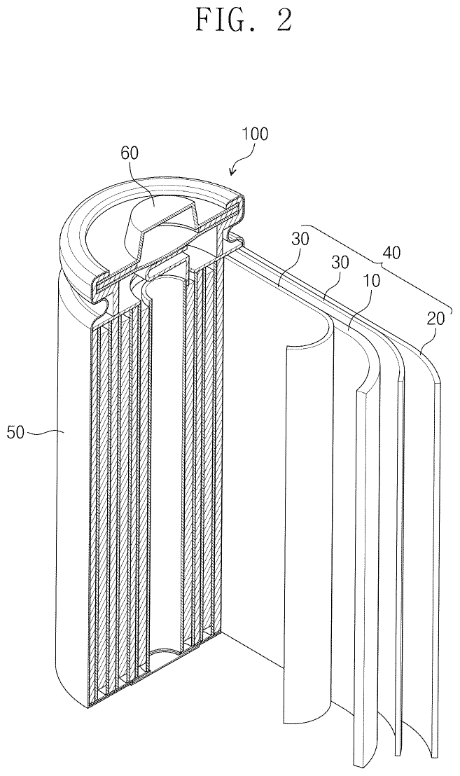

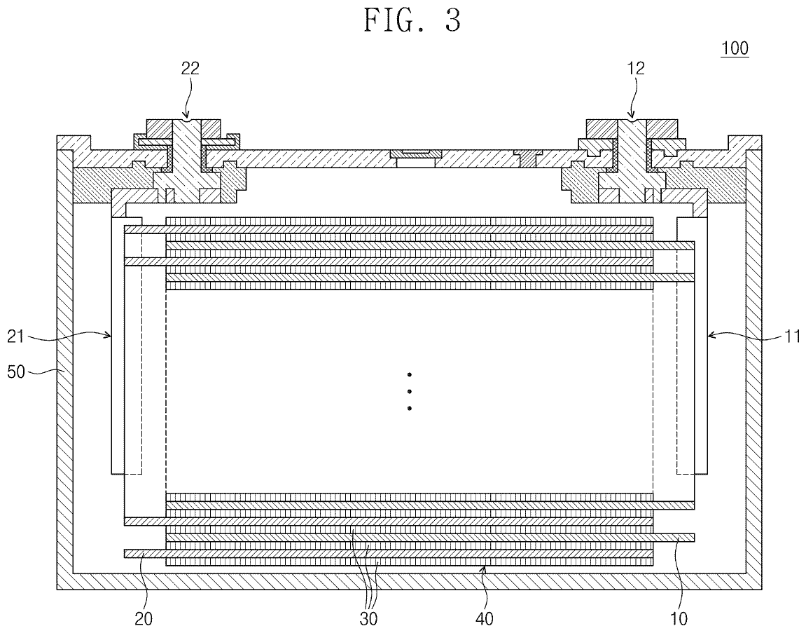

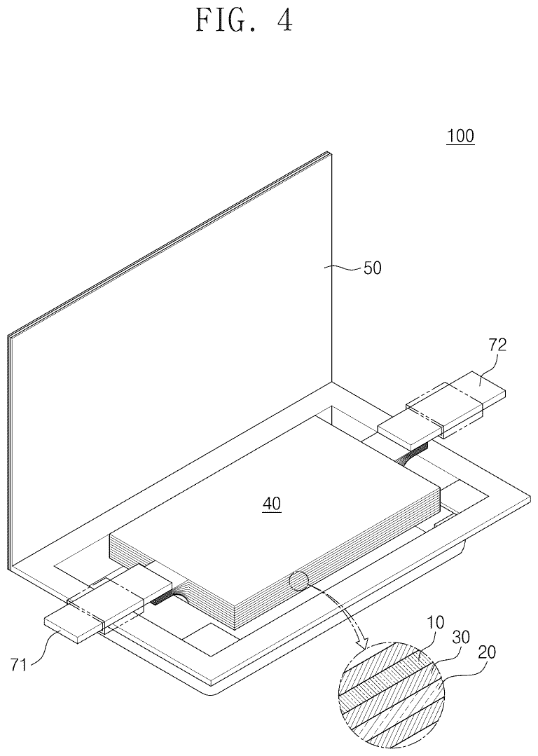

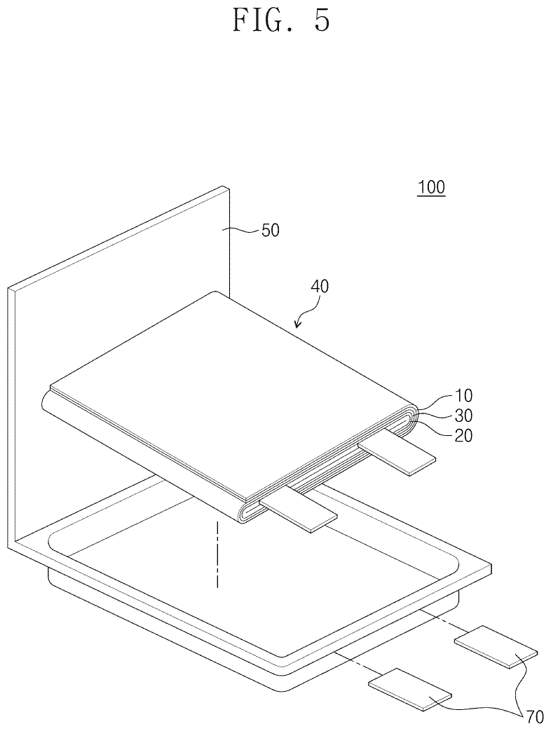

Based on a shape of a rechargeable lithium battery, the rechargeable lithium battery may be classified into cylindrical, prismatic, pouch, and coin types (kinds). In FIGS. 2 to 5 illustrating diagrams showing a rechargeable lithium battery according to one or more embodiments, FIG. 2 shows a cylindrical battery, FIG. 3 shows a prismatic battery, and FIGS. 4 and 5 show pouch-type (kind) batteries. Referring to FIGS. 2 to 4, a rechargeable lithium battery 100 may include an electrode assembly 40 in which a separator 30 is interposed between a positive electrode 10 and a negative electrode 20, and may also include a casing 50 in which the electrode assembly 40 is accommodated. The positive electrode 10, the negative electrode 20, and the separator 30 may be impregnated in an electrolyte. The rechargeable lithium battery 100 may include a sealing member 60 that seals the casing 50 as illustrated in FIG. 2. In addition, as illustrated in FIG. 3, the rechargeable lithium battery 100 may include a positive electrode lead tab 11, a positive electrode terminal 12, a negative electrode lead tab 21, and a negative electrode terminal 22. As shown in FIGS. 4 and 5, the rechargeable lithium battery 100 may include an electrode tab 70, or a positive electrode tab 71 and a negative electrode tab 72, which electrode tab 70 serves as an electrical path for externally inducing a current generated in the electrode assembly 40.

The following description will focus on a positive electrode according to one or more embodiments of the present disclosure.

A positive electrode according to one or more embodiments may include a positive electrode active material, a binder, a conductive material (e.g., electron conductor), and an additive. The additive according to one or more embodiments of the present disclosure may be represented by Chemical Formula 1-1 or Chemical Formula 1-2.

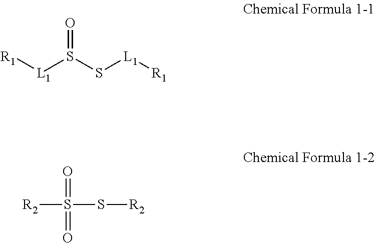

In Chemical Formula 1-1, L₁ may each independently be a substituted or unsubstituted C1 to C10 alkylene group, R₁ may each independently be hydrogen, a C1 to C20 alkyl group, a C2 to C20 alkenyl group, a C2 to C20 alkynyl group, a C3 to C20 cycloalkyl group, or a C6 to C20 aryl group, and at least one of R₁ may be a C2 to C20 alkenyl group.

In Chemical Formula 1-2, R₂ may each independently be hydrogen, a C1 to C20 alkyl group, a C2 to C20 alkenyl group, a C2 to C20 alkynyl group, a C3 to C20 cycloalkyl group, or a C6 to C20 aryl group, and at least one of R₂ may be a C6 to C20 aryl group.

The additive according to one or more embodiments of the present disclosure may include a structure, S—S═O, in which an oxygen atom is doubly bonded to disulfide. The bonding structure may stabilize the positive electrode by eliminating unstable oxygen (e.g., reactive oxygen species) generated around the positive electrode active material due to positive electrode degradation. In addition, the bonding structure may stabilize the positive electrode by contributing to the formation of a robust cathode electrolyte interface (CEI) on a surface of the positive electrode.

In a rechargeable lithium battery, unstable oxygen may be generated internally as charge and discharge cycles are repeated. The unstable oxygen may attack the surface of the positive electrode, leading to degradation of the positive electrode. The bonding structure may effectively or suitably remove the unstable oxygen, significantly improving the degradation of the positive electrode. Therefore, the additive according to the present disclosure may cause an improvement in battery performance. The positive electrode stabilization effect of the bonding structure may become more pronounced at high temperatures. For example, the high temperature may be equal to or greater than about 138° C. or equal to or greater than about 200° C.

In Chemical Formula 1-1, at least one of R₁ may include carbon having a double bond. For example, in Chemical Formula 1-1, all of R₁ may have an allyl group structure. For another example, in Chemical Formula 1-1, only one of R₁ may include an allyl group structure.

In one or more embodiments, Chemical Formula 1-1 may be a compound represented by Chemical Formula 1-1A, or Chemical Formula 1-1B, or Chemical Formula 1-1C. For example, the additive represented by Chemical Formula 1-1 may be at least one selected from among S-allyl prop-2-ene-1-sulfinothioate (Allicin), or S-propyl prop-2-ene-1-sulfinothioate, or S-allyl ethanesulfinothioate.

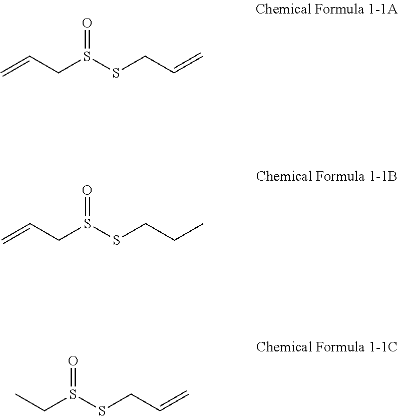

The additive according to one or more embodiments of the present disclosure may include an allyl group. For example, the additive represented by Chemical Formula 1-1 may include an allyl group located at a terminal, and thus a polymerization reaction may easily and successively occur during SEI film formation. Therefore, the additive according to one or more embodiments of the present disclosure may form a relatively thick and high-density SEI film due to the chain polymerization reaction.

In Chemical Formula 1-2, at least one of R₂ may include an aryl group. For example, in Chemical Formula 1-2, all of R₂ may have a phenyl group structure. For another example, in Chemical Formula 1-2, only one of R₂ may include a phenyl group structure.

In one or more embodiments, Chemical Formula 1-2 may be a compound represented by Chemical Formula 1-2A or Chemical Formula 1-2B. For example, the additive represented by Chemical Formula 1-2 may be one or both (e.g., simultaneously) of S-phenyl benzenesulfonothioate and S-phenyl ethanesulfinothioate.

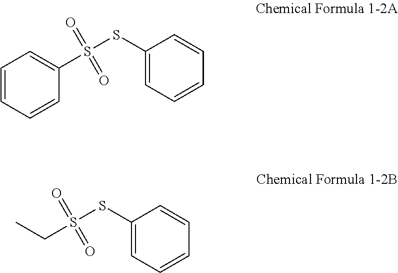 [SMILES: O=S(=O)(Sc1ccccc1)c1ccccc1 ; CCS(=O)(=O)Sc1ccccc1]

The additive according to one or more embodiments of the present disclosure may include at least one phenyl group. For example, the additive represented by Chemical Formula 1-2 may include a phenyl group located at a terminal to contribute to the formation of a robust cathode electrolyte interface (CEI) on the surface of the positive electrode, thereby stabilizing the positive electrode.

As the additive according to the present disclosure includes a structure (S—S═O) in which an oxygen atom is doubly bonded to disulfide and a specific functional group at a terminal, the effects discussed above may be even more effectively or suitably achieved. The structural features of the additive according to the present disclosure may exhibit significantly excellent or suitable positive electrode stabilization effects compared to additives containing only an allyl group or a phenyl group.

The additive may be included in an amount of about 0.01 parts by weight to about 10 parts by weight, about 0.03 parts by weight to about 8 parts by weight, about 0.05 parts by weight to about 7 parts by weight, or about 0.1 parts by weight to about 5 parts by weight relative to the total 100 parts by weight of the positive electrode active material, the binder, and the conductive material (e.g., electron conductor). In one or more embodiments, the additive may be included in an amount of about 0.1 parts by weight to about 5 parts by weight relative to the total 100 parts by weight of the positive electrode active material, the binder, and the conductive material (e.g., electron conductor). When the amount of the additive is less than the ranges above, the additive may fail to adequately remove unstable oxygen to cause a lack of positive electrode stabilization effect. When the amount of the additive is greater than the ranges above, the additive itself may act as a resistance-causing material to create a lack of positive electrode stabilization effect. When the amount of the additive falls within the ranges above, resistance increase suppression at high temperatures and high-temperature storage effect may be maximized or increased due to positive electrode stabilization.

The positive electrode active material may include a compound (e.g., a lithiated intercalation compound) that reversibly can intercalate and de-intercalate lithium. The positive electrode active material may include lithium composite oxide represented by Chemical Formula 2.

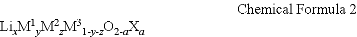

In Chemical Formula 2,
a, x, y, and z may satisfy the relationship of 0.5≤x≤1.8, 0≤a≤0.05, 0<y≤1, 0≤z≤1, and 0≤y+z≤1.

M¹, M², and M³ may each independently include at least one element selected from among metals such as Ni, Co, Mn, Al, B, Ba, Ca, Ce, Cr, Fe, Mo, Nb, Si, Sr, Mg, Ti, V, W, Zr, La, and/or a (e.g., any suitable) combination thereof.

X may include at least one element selected from among F, S, P, and Cl.

In one or more embodiments, in Chemical Formula 2, M¹ may be Ni, y may be 0.8≤y≤1, and z may be 0≤z≤0.2. In one or more embodiments, in Chemical Formula 2, M¹ may be Ni, M² may be Co, and M³ may be Al. Dissimilarly, in Chemical Formula 2, M¹ may be Ni, M² may be Co, and M³ may be Mn.

The positive electrode active material may be present in an amount of about 90 wt % to about 98 wt % relative to the total weight of the positive electrode composition. Each of the conductive material (e.g., electron conductor) and the binder may be present in an amount of about 1 wt % to about 5 wt % relative to the total weight of the positive electrode composition.

The conductive material (e.g., electron conductor) may be used to provide an electrode with conductivity (e.g., electrical conductivity), and in constituting a battery, any suitable conductive material (e.g., electron conductor) without causing chemical change of the battery may be used as the conductive material (e.g., electron conductor), for example, a carbon-based material such as natural graphite, artificial graphite, carbon black, acetylene black, Ketjenblack, carbon fiber, carbon nano-fiber, and carbon nano-tube; a metallic material such as a metal powder or metal fiber containing one or more of copper, nickel, aluminum, and silver; a conductive polymer such as a polyphenylene derivative; and/or a (e.g., any suitable) mixture thereof.

The binder may serve to improve attachment of positive electrode active material particles to each other and also to improve attachment of the positive electrode active material to a current collector, and may include, but not limited to, polyvinyl alcohol, carboxymethyl cellulose, hydroxypropyl cellulose, diacetyl cellulose, polyvinylchloride, carboxylated polyvinylchloride, polyvinylfluoride, ethylene oxide-containing polymer, polyvinylpyrrolidone, polyurethane, polytetrafluoroethylene, polyvinylidene fluoride, polyethylene, polypropylene, styrene-butadiene rubber, acrylated styrene-butadiene rubber, epoxy resin, or nylon.

In one or more embodiments of the present disclosure, a rechargeable lithium battery may be provided to include the positive electrode discussed above, a negative electrode including a negative electrode active material, and an electrolyte for the rechargeable lithium battery.

The positive electrode may include a positive electrode current collector and a positive electrode active material layer positioned on the positive electrode current collector, and the positive electrode active material layer may include the positive electrode active material mentioned above.

The positive electrode active material, the binder, and the conductive material (e.g., electron conductor) may be mixed and dispersed in an organic solvent to prepare a positive electrode slurry composition, and the positive electrode slurry composition may be coated on a positive electrode current collector, dried, and then pressed to manufacture the positive electrode.

The negative electrode may include a negative electrode current collector and a negative electrode active material layer including a negative electrode active material formed on the negative electrode current collector.

The negative electrode active material may include a material that can reversibly intercalate and deintercalate lithium ions, lithium metal, a lithium metal alloy, a material that can dope and de-dope lithium, or transition metal oxide.

In one or more embodiments, the negative electrode active material may include at least one selected from among graphite and silicon composites.

When the negative electrode active material includes both (e.g., simultaneously) a silicon composite and graphite, the silicon composite and the graphite may be present in the form of a mixture, and in this case, the silicon composite and the graphite may be included in a weight ratio of about 1:99 to about 50:50. For example, the silicon composite and the graphite may be included in a weight ratio of about 3:97 to about 20:80 or about 5:95 to about 20:80.

The silicon composite may include a core including silicon-based particles and an amorphous carbon coating layer, and the silicon-based particle may include at least one selected from among a silicon-carbon composite, SiOx (where 0<x≤2), and a silicon alloy. For example, the silicon-carbon composite may include a core including silicon particles and crystalline carbon, and may also include an amorphous carbon coating layer positioned on a surface of the core. The crystalline carbon may include graphite, for example, natural graphite, artificial graphite, and/or a (e.g., any suitable) mixture thereof.

The electrolyte may be prepared by a mixing process in which a lithium salt is dissolved in a non-aqueous organic solvent and the additive is added to mix. The electrolyte mixing process is suitable in electrolyte fabrication field, and a person skilled in the art will be able to appropriately or suitably select and use.

The non-aqueous organic solvent may include at least one selected from among ethylmethyl carbonate (EMC), ethylene carbonate (EC), dimethyl carbonate (DMC), propylene carbonate (PC), propyl propionate (PP), diethyl carbonate (DEC), dipropyl carbonate (DPC), methylpropyl carbonate (MPC), ethylpropyl carbonate (EPC), methylethyl carbonate (MEC), and butylene carbonate (BC).

In one or more embodiments, the non-aqueous organic solvent may be a mixed solvent of ethylmethyl carbonate (EMC), ethylene carbonate (EC), and dimethyl carbonate (DMC).

For example, the ethylene carbonate (EC) may be included in an amount of about 10 vol % to about 40 vol % relative to the total volume of the non-aqueous organic solvent. The ethylmethyl carbonate (EMC) may be included in an amount of about 20 vol % to about 70 vol % relative to the total volume of the non-aqueous organic solvent. The dimethyl carbonate (DMC) may be included in an amount of about 20 vol % to about 70 vol % relative to the total volume of the non-aqueous organic solvent.

For example, the lithium salt may include one or more of LiPF₆, LiClO₄, LiBF₄, lithium bis(fluorosulfonyl)imide (LiFSI), lithium bis(trifluoromethanesulfonyl)imide (LiTFSI), LiSO₃CF₃, LiBOB, LiFOB, LiDFBP, LiTFOP, LiPO₂F₂, LiSbF₆, LiAsF₆, LiAlO₂, LiAlCl₄, LiCl, LiI, LiN (SO₃C₂F₅)₂, Li(FSO₂)₂N, and LiC₄F₉SO₃. According to one or more embodiments, the lithium salt may include LiPF₆.

1 The lithium salt may have a concentration of about 0.1 M to about 2.0 M. For example, the lithium salt may have a concentration of equal to or greater than about 0.5 M or equal to or greater than about 1.0 M. The lithium salt may have a concentration of equal to or less than about 2.0 M, equal to or less than about 1.7 M, or equal to or less than about 1.5 M. In the present disclosure, if (e.g., when) the lithium salt has a concentration of about 0.1 M to about 2.0 M, the electrolyte may appropriately or suitably maintain its conductivity and viscosity.

In a rechargeable lithium battery, degradation of a positive electrode film and a negative electrode film may occur due to attack of acid generated within the battery. In the rechargeable lithium battery according to one or more embodiments of the present disclosure, a non-aqueous electrolyte may be decomposed during an initial charge/discharge to form a film having passivation ability on the surfaces of the positive and negative electrodes to improve high-temperature storage characteristics. The film may be deteriorated due to acid such as HF⁻ and PF₅⁻ produced by thermal decomposition of lithium salts (LiPF₆ and/or the like) used in lithium ion batteries. In one or more embodiments, this acid attack may elute transition metal elements from the positive electrode and increase an electrode surface resistance caused by a structural change of the surface. Thus, a theoretical capacity may be reduced due to loss of metal elements which are redox (reduction and oxidation) centers, which may result in a reduction in capacity. In addition, the eluted transition metal ions may be electrodeposited on the negative electrode that reacts in a strong reduction potential range. The transition metal ions may consume electrons while being electrodeposited on the negative electrode, and may destroy or damage the film to expose the negative electrode surface. This may lead to an additional decomposition reaction of the electrolyte. Thus, there may be an increase in resistance of the negative electrode and in irreversible capacity, and as a result, there may be a problem of continuous (e.g., substantially continuous) reduction in cell capacity.

In a rechargeable lithium battery according to the present disclosure, as the additive includes both (e.g., simultaneously) of a structure (S—S═O) in which an oxygen atom is doubly bonded to disulfide and a specific functional group located at a terminal, it may be possible to remove reactive oxygen species and strengthen the positive electrode film. Therefore, degradation of the positive electrode may be effectively prevented or reduced. As a result, the rechargeable lithium battery according to the present disclosure may exhibit excellent or suitable electrochemical performance. The effects may become more pronounced at high temperatures.

Again, in a rechargeable lithium battery, acid generated within the battery may degrade the positive and negative electrode films, leading to reduced capacity and increased resistance. This degradation occurs due to the decomposition of lithium salts, which produces acids that attack the electrodes. The eluted transition metal ions may deposit on the negative electrode, further damaging it and causing additional electrolyte decomposition. However, in the disclosed battery, an additive with a specific structure may remove reactive oxygen species and strengthen the positive electrode film, effectively preventing or reducing degradation and enhancing or improving electrochemical performance, especially at high temperatures.

The rechargeable lithium battery may be applied to automotive vehicles, mobile phones, and/or any other electrical devices, but the present disclosure is not limited thereto.

The following will describe one or more embodiments and comparative examples of the present disclosure. The following embodiments, however, are merely examples, and the present disclosure is not limited to one or more embodiments discussed.

### Embodiments and Comparatives

### Embodiment 1: Manufacture of Positive Electrode

An additive was added to a mixed solution where a positive electrode active material, a conductive material, and a binder were dispersed in a weight ratio of 97.7:1.2:1.1 in N-methyl-2-pyrrolidone (NMP), and then a mechanical agitator was used to stir the mixture for 30 minutes to prepare a positive electrode active material slurry. The additive was added in an amount of 0.1 parts by weight relative to total 100 parts by weight of the positive electrode active material, the conductive material, and the binder.

LiNi_{0.91}Co_{0.08}Al_{0.01}O₂ (NCA) was used as the positive electrode active material, artificial graphite was used as the conductive material, and polyvinylidenefluoride (PVdF) was used as the binder. A substance represented by Chemical Formula 1-1A was used as the additive.

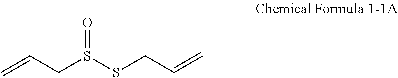

A doctor blade was used to coat the prepared positive electrode active material slurry of 60 μm in thickness on an aluminum current collector of 20 μm in thickness, dried in a hot-air drier for 0.5 hours at 100° C., dried again for 4 hours at 120° C. under a vacuum condition, and then roll-pressed to manufacture a positive electrode.

### (2) Fabrication of Rechargeable Lithium Battery

98 wt % of a negative electrode active material containing artificial graphite and a silicon composite mixed in a weight ratio of 95.8:4.2, 1 wt % of styrene-butadiene rubber (SBR), and 1 wt % of carboxymethyl cellulose (CMC) were mixed and added to distilled water, and then stirred for 60 minutes by using a mechanical agitator to prepare a negative electrode active material slurry. A doctor blade was used to coat the negative electrode active material slurry of 60 μm in thickness on a copper current collector of 10 μm in thickness, dried in a hot-air drier for 0.5 hours at 100° C., dried again for 4 hours 120° C. under a vacuum condition, and then roll-pressed to manufacture a negative electrode.

1.15 M of LiPF₆ was dissolved in a non-aqueous organic solvent containing ethylene carbonate (EC), ethylmethyl carbonate (EMC), and dimethyl carbonate (DMC) mixed in a volume ratio of about 20:40:40 to prepare an electrolyte.

The positive electrode, the negative electrode, and a polyethylene separator of 16 μm in thickness were assembled to manufacture an electrode assembly, and the electrolyte was introduced to fabricate a rechargeable lithium battery.

### Embodiment 2

A positive electrode and a rechargeable lithium battery were each fabricated in independently the same method as that in Embodiment 1, except that the use of 0.3 parts by weight of the additive represented by Chemical Formula 1-1A.

### Embodiment 3

A positive electrode and a rechargeable lithium battery were each fabricated in independently the same method as that in Embodiment 1, except that the use of 0.5 parts by weight of the additive represented by Chemical Formula 1-1A.

### Embodiment 4

A positive electrode and a rechargeable lithium battery were each fabricated in independently the same method as that in Embodiment 1, except that the use of 5.0 parts by weight of the additive represented by Chemical Formula 1-1A.

### Embodiment 5

A positive electrode and a rechargeable lithium battery were each fabricated in independently the same method as that in Embodiment 1, except that 0.1 parts by weight of an additive represented by Chemical Formula 1-2A was used in place of an additive represented by Chemical Formula 1-1A.

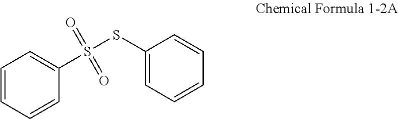 [SMILES: O=S(=O)(Sc1ccccc1)c1ccccc1]

### Comparative 1

A positive electrode and a rechargeable lithium battery were each fabricated in independently the same method as that in Embodiment 1, except that the additive represented by Chemical Formula 1-1A was not used if (e.g., when) the positive electrode was manufactured.

### Comparative 2

A positive electrode and a rechargeable lithium battery were each fabricated in independently the same method as that in Embodiment 1, except that 0.1 parts by weight of an additive represented by Chemical Formula 3-1 was used in place of the additive represented by Chemical Formula 1-1A.

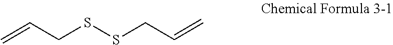

### Comparative 3

A positive electrode and a rechargeable lithium battery were each fabricated in independently the same method as that in Embodiment 1, except that 0.1 parts by weight of an additive represented by Chemical Formula 3-2 was used in place of the additive represented by Chemical Formula 1-1A.

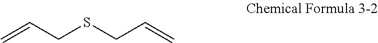

Table 1 lists positive electrode compositions according to the examples and the comparative examples.

TABLE 1

| | Positive electrode | | Conductive | | | | | |
|---|---|---|---|---|---|---|---|---|
| | active material | | material | | Binder | | Additive | |
| | | Amount | | Amount | | Amount | | Amount |
| | | (part by | | (part by | | (part by | | (part by |
| | Kind | weight) | Kind | weight) | Kind | weight) | Kind | weight) |
| Compar- | NCA | 97.7 | Graphite | 1.2 | PVdF | 1.1 | — | — |
| ative 1 | | | | | | | | |
| Compar- | NCA | 97.7 | Graphite | 1.2 | PVdF | 1.1 | Chemical | 0.1 |
| ative 2 | | | | | | | Formula 3-1 | |
| Compar- | NCA | 97.7 | Graphite | 1.2 | PVdF | 1.1 | Chemical | 0.1 |
| ative 3 | | | | | | | Formula 3-2 | |
| Embodi- | NCA | 97.7 | Graphite | 1.2 | PVdF | 1.1 | Chemical | 0.1 |
| ment 1 | | | | | | | Formula 1-1A | |
| Embodi- | NCA | 97.7 | Graphite | 1.2 | PVdF | 1.1 | Chemical | 0.3 |
| ment 2 | | | | | | | Formula 1-1A | |
| Embodi- | NCA | 97.7 | Graphite | 1.2 | PVdF | 1.1 | Chemical | 0.5 |
| ment 3 | | | | | | | Formula 1-1A | |
| Embodi- | NCA | 97.7 | Graphite | 1.2 | PVdF | 1.1 | Chemical | 5.0 |
| ment 4 | | | | | | | Formula 1-1A | |
| Embodi- | NCA | 97.7 | Graphite | 1.2 | PVdF | 1.1 | Chemical | 0.1 |
| ment 5 | | | | | | | Formula 1-2A | |

### Evaluation Example

The rechargeable lithium batteries were evaluated by the following methods.

### Evaluation 1: Charge/Discharge Characteristics at Room Temperature

Each of the rechargeable lithium batteries fabricated according to the examples and the comparative examples was charged and discharged at 25° C. for 300 cycles under the conditions of 0.5 C charge (CC/CV, 4.25 V, 0.05 C Cut-off) and 0.5 C discharge (CC, 2.8 V Cut-off), and a capacity retention rate was calculated and listed in Table 2. The capacity retention rate was calculated according to Equation 1.

$$Capacity retention rate ( \% ) = ( discharge capacity after 300 cycles / initial discharge capacity ) \times 100 \qquad Equation 1$$

TABLE 2

| Category | Capacity retention rate (%) |
|---|---|
| Comparative 1 | 85.6 |
| Comparative 2 | 89.0 |
| Comparative 3 | 87.2 |
| Embodiment 1 | 93.2 |
| Embodiment 2 | 93.7 |
| Embodiment 3 | 95.7 |
| Embodiment 4 | 96.5 |
| Embodiment 5 | 92.4 |

### Evaluation 2: High-Temperature Resistance Test

Each of the rechargeable lithium batteries fabricated in the examples and the comparative examples was charged 4.3 V at 45° C., an initial resistance value and a resistance value after 7 days at 60° C. were measured, and then the results were listed in Table 3. The resistance value was measured by using electrochemical impedance spectroscopy (EIS).

TABLE 3

| | Initial | Resistance after 7 days during |
|---|---|---|
| | resistance | high-temperature storage |
| | (Re(Z)/Ohm) | (Re(Z)/Ohm) |
| Comparative 1 | 13.8 | 21.2 |
| Comparative 2 | 13.7 | 21.2 |
| Comparative 3 | 15.7 | 24.6 |
| Embodiment 1 | 8.4 | 16.2 |
| Embodiment 2 | 7.5 | 14.2 |
| Embodiment 3 | 7.7 | 11.2 |
| Embodiment 4 | 10.5 | 19.4 |
| Embodiment 5 | 8.8 | 18.0 |

### Evaluation 3: Thermal Exposure

Each of the rechargeable lithium batteries fabricated according to the examples and the comparative examples was exposed for 1 hour at a target temperature (high temperature), was evaluated whether ignition occurred or not, and then the result was shown in Table 4. When a temperature was raised from room temperature to the target temperature, a temperature rise rate was maintained at 5° C./min. At this time, the occurrence of ignition was checked and the result was shown in Table 4.

TABLE 4

| Target | | | | |
|---|---|---|---|---|
| temperature | 134° C. | 136° C. | 138° C. | 140° C. |
| Comparative 1 | Non-ignition | Ignition | — | — |
| Comparative 2 | Non-ignition | Ignition | — | — |
| Comparative 3 | Non-ignition | Ignition | — | — |
| Embodiment 1 | Non-ignition | Non-ignition | Non-ignition | Non-ignition |
| Embodiment 2 | Non-ignition | Non-ignition | Non-ignition | Non-ignition |
| Embodiment 3 | Non-ignition | Non-ignition | Non-ignition | Non-ignition |
| Embodiment 4 | Non-ignition | Non-ignition | Non-ignition | Ignition |
| Embodiment 5 | Non-ignition | Non-ignition | Non-ignition | Ignition |

### Comprehensive Evaluation

Referring to Table 2, it is ascertained that, compared to the comparative examples, there was in an improvement in capacity retention rate in accordance with charge/discharge cycles at room temperature in the examples (Embodiments 1 to 5) each of which used the positive electrode to which the additive according to the present disclosure was added.

Referring to Table 3, it is ascertained that, compared to the comparative examples, the resistance at a high temperature (60° C.) was more effectively suppressed or reduced in the examples (Embodiments 1 to 5) each of which used the positive electrode to which the additive according to the present disclosure was added.

Referring to Table 4, if (e.g., when) using the positive electrodes (Embodiments 1 to 5) according to the present disclosure, it was possible to withstand heat up to 138° C. to 140° C. It is thus confirmed that, compared to the comparative examples, there was an improvement in thermal stability characteristics (thermal runaway and positive electrode degradation) in the examples each of which used the positive electrode to which the additive according to the present disclosure was added.

In a positive electrode according to one or more embodiments, an additive may be used to exhibit improved stability.

A rechargeable lithium battery including the positive electrode may have excellent or suitable lifespan characteristics and stability.

A battery manufacturing device, a battery management system (BMS) device, and/or any other relevant devices or components according to embodiments of the present invention described herein may be implemented utilizing any suitable hardware, firmware (e.g. an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the present disclosure.

A person of ordinary skill in the art, in view of the present disclosure in its entirety, would appreciate that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

While this disclosure has been described in connection with example embodiments, it is understood that the present disclosure is not limited to these embodiments. It is intended to cover suitable modifications and equivalent arrangements within the spirit and scope of the appended claims and their equivalents. Therefore, the aforementioned embodiments should be considered as examples and should not limit this disclosure in any way.

What is claimed is:

1. A positive electrode comprising:
a positive electrode active material;
a binder;
a conductive material; and
an additive represented by Chemical Formula 1-1 or Chemical Formula 1-2, 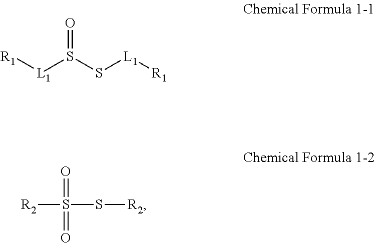
wherein, in Chemical Formula 1-1,
L₁ are each independently a substituted or unsubstituted C1 to C10 alkylene group,
R₁ are each independently hydrogen, a C1 to C20 alkyl group, a C2 to C20 alkenyl group, a C2 to C20 alkynyl group, a C3 to C20 cycloalkyl group, or a C6 to C20 aryl group, and
at least one of R₁ is a C2 to C20 alkenyl group,
wherein, in Chemical Formula 1-2,
R₂ are each independently hydrogen, a C1 to C20 alkyl group, a C2 to C20 alkenyl group, a C2 to C20 alkynyl group, a C3 to C20 cycloalkyl group, or a C6 to C20 aryl group, and
at least one of R₂ is a C6 to C20 aryl group, and
wherein the positive electrode is for a rechargeable lithium battery.

2. The positive electrode as claimed in claim 1, wherein Chemical Formula 1-1 comprises at least one selected from among compounds represented by Chemical Formula 1-1A, Chemical Formula 1-1B, or Chemical Formula 1-1C,

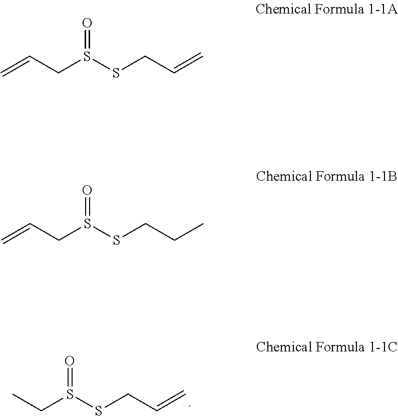

3. The positive electrode as claimed in claim 1, wherein Chemical Formula 1-2 comprises at least one selected from among compounds represented by Chemical Formula 1-2A or Chemical Formula 1-2B,

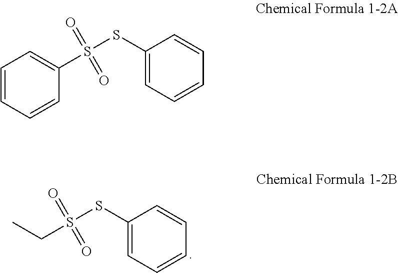 [SMILES: O=S(=O)(Sc1ccccc1)c1ccccc1 ; CCS(=O)(=O)Sc1ccccc1]

4. The positive electrode as claimed in claim 1, wherein the additive is included in an amount of about 0.1 parts by weight to about 5 parts by weight relative to total 100 parts by weight of the sum of the positive electrode active material, the binder, and the conductive material.

5. The positive electrode as claimed in claim 1, wherein the positive electrode active material is represented by Chemical Formula 2, 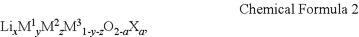
wherein, in Chemical Formula 2,
0.5≤x≤1.8, 0≤a≤0.05, 0<y≤1, 0≤z≤1, and 0≤y+z≤1.
M¹, M², and M³ each independently comprise at least one element selected from among metals such as Ni, Co, Mn, Al, B, Ba, Ca, Ce, Cr, Fe, Mo, Nb, Si, Sr, Mg, Ti, V, W, Zr, La, and a combination thereof, and
X comprises at least one element selected from among F, S, P, and Cl.

6. The positive electrode as claimed in claim 5, wherein M¹ of Chemical Formula 2 is Ni.

7. A rechargeable lithium battery, comprising:
the positive electrode as claimed in claim 1;
a negative electrode that comprises a negative electrode active material; and
an electrolyte for the rechargeable lithium battery.

8. The rechargeable lithium battery as claimed in claim 7, wherein the electrolyte comprises a lithium salt and an organic solvent.

9. The rechargeable lithium battery as claimed in claim 7, wherein the negative electrode active material comprises at least one selected from among graphite and silicon composites.

10. The rechargeable lithium battery as claimed in claim 9, wherein the Si composite comprises:
a core comprising Si-based particles; and
a coating layer comprising amorphous carbon.

11. The rechargeable lithium battery as claimed in claim 10, wherein the Si-based particles comprise one or more of a silicon-carbon composite, SiOx (0<x≤2), and a silicon alloy.

12. The rechargeable lithium battery as claimed in claim 7, wherein the rechargeable lithium battery is a cylindrical, prismatic, pouch-type, or coin-type battery.
